(19) United States
(12) Patent Application Publication
(10) Pub. No.: US 2015/0293681 A1
(43) Pub. Date: Oct. 15, 2015

(54) METHODS, SYSTEMS, AND MEDIA FOR PROVIDING A MEDIA INTERFACE WITH MULTIPLE CONTROL INTERFACES

(71) Applicant: Google Inc., Mountain View, CA (US)

(72) Inventors: Aaron Joseph Wheeler, San Francisco, CA (US); Sarah Hatem Ali, San Francisco, CA (US)

(21) Appl. No.: 14/611,863

(22) Filed: Feb. 2, 2015

Related U.S. Application Data
(60) Provisional application No. 61/977,213, filed on Apr. 9, 2014.

(51) Int. Cl. G06F 3/0484

(52) U.S. Cl. CPC G06F 3/04847; G06F 3/04842

(57) ABSTRACT

Methods, systems, and media for providing a media interface with multiple control interfaces are provided. In some embodiments, a method for media guidance is provided, the method comprising: causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to; determining that a portion of the control interface has been selected; and activating the selected portion of the control interface, wherein: the plurality of navigation options that navigate through the plurality of media content items are activated; and the plurality of media playback options that control playback of the media content item from the plurality of media content items.

### CROSS-REFERENCE TO RELATED APPLICATION

This application claims the benefit of U.S. Provisional Patent Application No. 61/977,213, filed Apr. 9, 2014, which is hereby incorporated by reference herein in its entirety.

### TECHNICAL FIELD

The disclosed subject matter relates to methods, systems, and media for providing a media interface with multiple control interfaces.

### BACKGROUND

Navigating a user interface using a directional input device frustrates many users because certain functions can only be performed by selecting a particular button on the input device, or by navigating to a particular location in the user interface. Many user input devices, such as remote controls, include buttons for performing specific actions in a user interface, but they can be hard to locate and the function which they perform may be unclear. Providing options in a particular location of the user interface requires the user to navigate to that particular location of the user interface, which may require many directional inputs depending on a portion of the user interface that is currently highlighted. In addition, for some user interfaces, the complexity of the user interface increases greatly with each additional content item that needs to be controlled.

Accordingly, it is desirable to provide methods, systems, and media for providing a media interface with multiple control interfaces.

### SUMMARY

In accordance with various embodiments of the disclosed subject matter, mechanisms providing a media interface with multiple control interfaces are provided.

In some embodiments of the disclosed subject matter, a method for media guidance is provided, the method comprising: causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface; determining that a portion of the control interface has been selected; and activating the selected portion of the control interface, wherein: the plurality of navigation options that navigate through the plurality of media content items are activated in response to determining that the first portion of the control interface has been selected; and the plurality of media playback options that control playback of the media content item from the plurality of media content items are activated in response to determining that the second portion of the control interface has been selected.

In some embodiments of the disclosed subject matter, a system for media guidance is provided, the system comprising a hardware processor that is configured to: cause a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface; determine that a portion of the control interface has been selected; and activate the selected portion of the control interface, wherein: the plurality of navigation options that navigate through the plurality of media content items are activated in response to determining that the first portion of the control interface has been selected; and the plurality of media playback options that control playback of the media content item from the plurality of media content items are activated in response to determining that the second portion of the control interface has been selected.

In some embodiments of the disclosed subject matter, non-transitory computer-readable media containing computer executable instructions that, when executed by a processor, cause the processor to perform a method for media guidance is provided, the method comprising: causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface; determining that a portion of the control interface has been selected; and activating the selected portion of the control interface, wherein: the plurality of navigation options that navigate through the plurality of media content items are activated in response to determining that the first portion of the control interface has been selected; and the plurality of media playback options that control playback of the media content item from the plurality of media content items are activated in response to determining that the second portion of the control interface has been selected.

In some embodiments of the disclosed subject matter, a system for media guidance is provided, the system comprising: means for causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface; means for determining that a portion of the control interface has been selected; and means for activating the selected portion of the control interface, wherein: the plurality of navigation options that navigate through the plurality of media content items are activated in response to determining that the first portion of the control interface has been selected; and the plurality of media playback options that control playback of the media content item from the plurality of media content items are activated in response to determining that the second portion of the control interface has been selected.

In some embodiments, the system further comprises means for causing the media content item to be presented concurrently with the media interface in response to determining that the media content item from the plurality of media content items has been selected using the first portion of the control interface.

In some embodiments, the system further comprises means for inhibiting the second portion of the control interface from being activated in response to determining that the first portion of the control interface has been selected.

In some embodiments, the system further comprises means for inhibiting the first portion of the control interface from being activated in response to determining that the second portion of the control interface has been selected.

In some embodiments, wherein the media interface includes a plurality of media identifiers and wherein each of the plurality of media identifiers includes an image that represents the media content item of the plurality of media content items.

In some embodiments, wherein the first portion is a top portion of the control interface and wherein the second portion is a bottom portion of the control interface.

In some embodiments, wherein the selected portion of the control interface is activated in response to receiving a user input to navigate in a vertical direction and wherein the system further comprises means for navigating through options associated with the selected portion of the control interface in response to receiving a user input to navigate in a horizontal direction.

In some embodiments, wherein the selected portion of the control interface is activated in response to receiving a user input to navigate in a horizontal direction and wherein the system further comprises means for navigating through options associated with the selected portion of the control interface in response to receiving a user input to navigate in a vertical direction.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a schematic diagram of a system, including a remote control and a media device, suitable for implementation of mechanisms described herein for providing a media interface that includes multiple control interfaces in accordance with some embodiments of the disclosed subject matter.

FIG. 2 shows an example of a process for providing a media interface that includes multiple control interfaces in accordance with some embodiments of the disclosed subject matter.

FIGS. 3A-3C show examples of a user interface that includes one or more media interfaces, where each media interface includes multiple control interfaces, in accordance with some embodiments of the disclosed subject matter.

### DETAILED DESCRIPTION

In accordance with some embodiments of the disclosed subject matter, mechanisms (which can include methods, systems, and/or media) for providing a media interface with multiple control interfaces are provided.

In some embodiments, the mechanisms described herein can cause a user interface that can be navigated using directional inputs received from a user input device to be presented. For example, a device using the mechanisms described herein can cause a user interface that includes one or more media interfaces corresponding to various media items that can be played back on the device to be presented. These media interfaces can be presented, for example, in a grid of media interfaces, as a column of media interfaces, as a row of media interfaces, as multiple rows of media interfaces with each row representing a group of related media interfaces, and/or using any other suitable technique or techniques.

It should be noted that the one or more media interfaces can include any suitable information for presentation. For example, in some embodiments, the media interface can identify a media content item that corresponds to the media interface. In a more particular example, the media interface can include any suitable identifier, such as a thumbnail, an image, and/or any suitable text. In some embodiments, how a particular identifier is presented can be based on one or more items of metadata associated with the media content with which the media interface is associated. For example, the media identifier can include title information based on title metadata of the media content. As another example, the media identifier can include an image based on thumbnail metadata of the media content and/or a frame of image data from the metadata of the media content.

It should also be noted that the media content item that corresponds to a media interface can include any suitable type(s) of media content. For example, media content can include audio content and/or video content. As another example, media content can include print media content or image media content. As still another example, media content can include a collection of media content, such as a playlist of videos, a playlist of songs, a collection of images, etc. As a further example, media content can include subscription based media content, such as podcasts, online magazine subscriptions, etc. As another further example, media content can include interactive media content, such as applications and video games. Media content can include any suitable combinations of content and/or any other suitable content.

In some embodiments, the mechanisms described herein can receive directional inputs (e.g., issued by a user input device), and can highlight or place in focus a particular media interface based on the received directional input. For example, in response to determining that the media interface represents a playlist or collection of media content items, the mechanisms described herein can cause various media identifiers corresponding to the videos to be sequentially highlighted in response to a device using the mechanisms receiving directional inputs. In a more particular example, the mechanisms described herein can cause a first media interface corresponding to a first video to be highlighted.

In some embodiments, the media interface can include multiple control interfaces. For example, the media interface can include a control interface, where a first portion can occupy the top of portion of the control interface and a second portion can occupy the bottom portion of the control interface. In a more particular example, the first portion of the control interface can include navigation options (e.g., for navigating through multiple media content items when the media interface represents a collection of media content items). In another more particular example, the second portion of the control interface can include media playback options (e.g., for controlling the playback and/or presentation of the currently presented media content item). Media playback options can include any suitable media playback option, such as playing the media content item, pausing the media content item, rewinding the media content item, fast forwarding the media content item, stopping the media content item, skipping the media content item, liking the media content item or providing any other suitable indication of sentiment, requesting that related media content items be presented, placing the media content item in a queue for consumption at a later time, subscribing to a content provider providing the media content item, accessing other content items provided by the content provider that is providing the media content item, and/or any other suitable media playback option relating to the selected media content item.

In some embodiments, the mechanisms can determine that a portion of the control interface has been selected. For example, the mechanisms can determine that one of the multiple portions of the control interface has been highlighted and/or placed in focus by the user. It should be noted that, in some embodiments, the selection of a portion of the control interface can activate particular controls and respond to particular inputs, such as directional inputs from a user input interface. It should also be noted that, in some embodiments, while the selection of a particular portion of the control interface can activate particular controls, such a selection can also inhibit other controls from being activated (e.g., allow the user to select from multiple navigation options and de-activate media playback options).

In a more particular example, the mechanisms can determine that a first portion of the control interface that includes navigation options has been selected using a user input interface (e.g., by pressing a down button on a remote control from a highlighted media interface). The navigation options can be activated, which are responsive to particular directional inputs from the user input interface. For example, in response to receiving left and/or right directional inputs from the user input interface, the navigation options can cause the media interface to navigate through media content items. In another example, the navigation options can indicate where in the list or collection of media content items is currently being played back and/or indicate where in the list or collection of media content items that the user has currently navigated (e.g., the third media content item in a list containing five media content items).

In another more particular example, the mechanisms can determine that a second portion of the control interface that includes media playback options has been selected using a user input interface (e.g., by pressing a down button on a remote control from the activated navigational options in the control interface). The media playback options can be activated, which are also responsive to particular directional inputs from the user input interface. For example, in response to receiving left and/or right directional inputs from the user input interface, the user can select from one or more media playback options relating to the selected media content item.

It should be noted that, in some embodiments, control interfaces and/or their respective control options can be selected based on any suitable criterion. For example, media playback options in a control interface can be selected based on media type (e.g., particular options for video playback), media interface type (e.g., particular options for a playlist of media content items), content creator (e.g., particular options for accessing or subscribing to other content), user information (e.g., particular options for sharing and/or social media), etc.

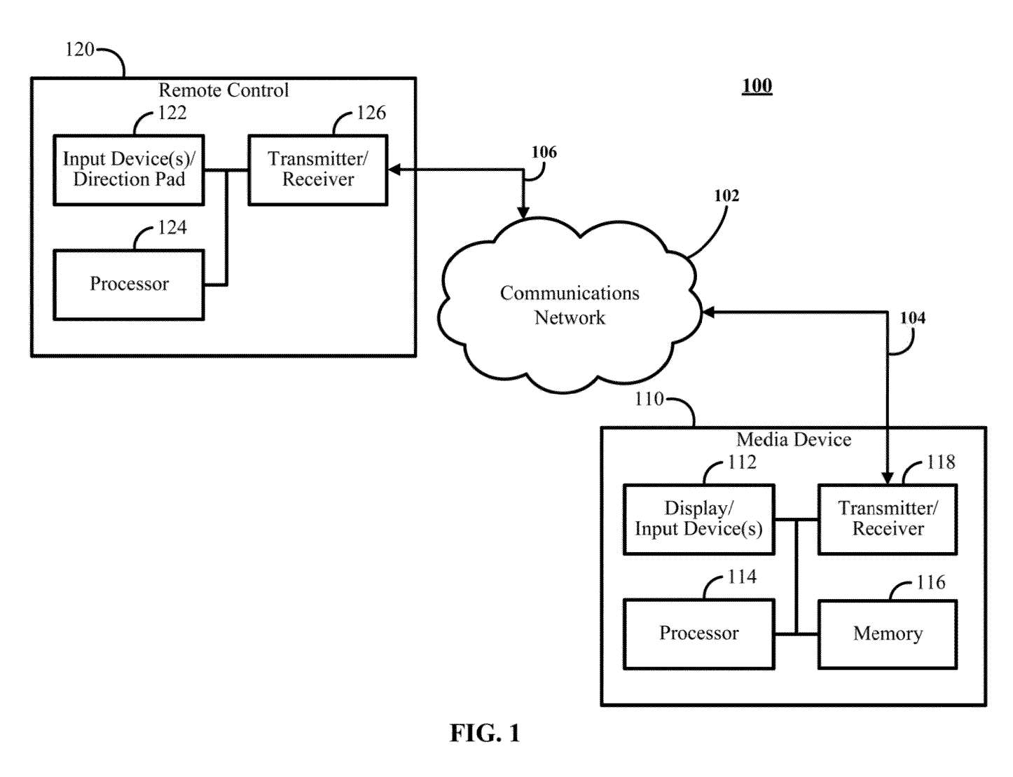

These and other features for providing a media interface with multiple control interfaces are described herein in connection with FIGS. 1-3C.

FIG. 1 shows an example 100 of a generalized schematic diagram of a system that includes a media device and a remote control on which the mechanisms for providing a media interface with multiple control interfaces as described herein can be implemented in accordance with some embodiments of the disclosed subject matter. As illustrated, system 100 can include a remote control 120 that can be used to control one or more media devices, such as a media device 110. Remote control 120 can be connected by a communications link 106 to a communications network 102 that can be linked via a communications link 104 to media device 110.

In a more particular example, remote control 120 can include an input device(s)/direction pad 122 and/or any other suitable directional input. For example, input device(s)/direction pad 122 can include a direction pad and a select button. Additionally or alternatively, any other suitable buttons or other input devices can be included in input device(s)/direction pad 122 such as number buttons, volume and channel controls, etc. In some embodiments, remote control 120 can further include a processor 124, and a transmitter/receiver 126, which can be interconnected with each other and/or with input device(s)/direction pad 122.

In some embodiments, remote control 120 can include memory and/or storage (not shown) for storing a computer program for controlling processor 124. For example, the computer program can be stored in read-only memory (ROM), electrically programmable read only memory (EPROM), electrically erasable programmable read only memory (EEPROM), flash memory, etc.

Processor 124 can use the computer program to cause signals to be transmitted from remote control 120 through communications link 106 and communications network 102 to media device 110 via communications link 104. These signals can be transmitted using transmitter/receiver 126, which can include one or more transmitters, receivers, antennas, transmitter/receivers, etc. Transmitter/receiver 126 can transmit and/or receive signals using any suitable technologies and/or frequencies. For example, transmitter/receiver 126 can transmit and/or receive radio signals, infrared signals, near-infrared signals, ultrasonic signals, etc.

Communications links 104 and 106 can be any communications links suitable for communicating data between remote control 120 and media device 110, such as radio frequency links, infrared links, near-infrared links, wireless links, network links, HDMI links, USB links, any other suitable communications links, or any suitable combination of such links. In some embodiments, communication link 104 and communication link 106 can be the same communication link or different communication links. For example, a radio signal (such as a microwave signal) can be sent from remote control 120 through communications network 102 (e.g., a space between remote control 120 and media device 110), which can then be received at media device 110. In such an example, communication link 104 and communication link 106 are the same (e.g., the microwave signal).

As another example, a radio signal (such as a microwave signal) can be sent from remote control 120 and received at a converter (not shown) that converts the microwave signal to a near-infrared signal. In such an example, the converter can transmit the near-infrared signal, which can then be received by media device 110. In this example, communication link 106 is the radio signal, and communication link 104 is the near-infrared signal and the converter is part of communications network 102.

In some embodiments, input device(s)/direction 122 can include a number of switches that, when activated, indicate a directional input. For example, input device(s)/direction 122 can include a button that a user can press to indicate a direction. This button can activate one or more of the switches, and a signal from the one or more switches can be correlated by processor 124 with a direction indicated by pressing the button.

Input device(s)/direction 122 and processor 124 can be configured to accept any suitable number of inputs for various directions in accordance with some implementations. For example, processor 124 can be configured to detect inputs in four directions (e.g., up, down, left and right) from input device(s)/direction 122. In another example, processor 124 can be configured to detect eight directional inputs (e.g., up, down, left, right and intermediate directions, such as, up-right diagonal, up-left diagonal, down-right diagonal, and down-left diagonal) from input device(s)/direction 122. In yet another example, processor 124 can be configured to detect inputs in any arbitrary direction from input device(s)/direction 122. In such an example, input device(s)/direction 122 can include touch sensors that can be used to detect an arbitrary position of an input to input device(s)/direction 122.

In some embodiments, input device(s)/direction 122 can include any other suitable features such as an alphanumeric keypad, a power button, an input selection button, channel buttons, volume buttons, a volume mute button, media playback buttons (e.g., rewind, pause, play, and fast-forward buttons), a dedicated button that accesses downloadable applications for use by the media device, a microphone or other suitable audio input, a camera, etc. In some embodiments, input device(s)/direction 122 can include hardware buttons and/or software buttons (e.g., programmable buttons). In some implementations, input device(s)/direction 122 can also include other inputs, such as, a computer keyboard, a cursor-controller, a dial, a switchbank, a lever, a touchscreen, and/or any other suitable input device.

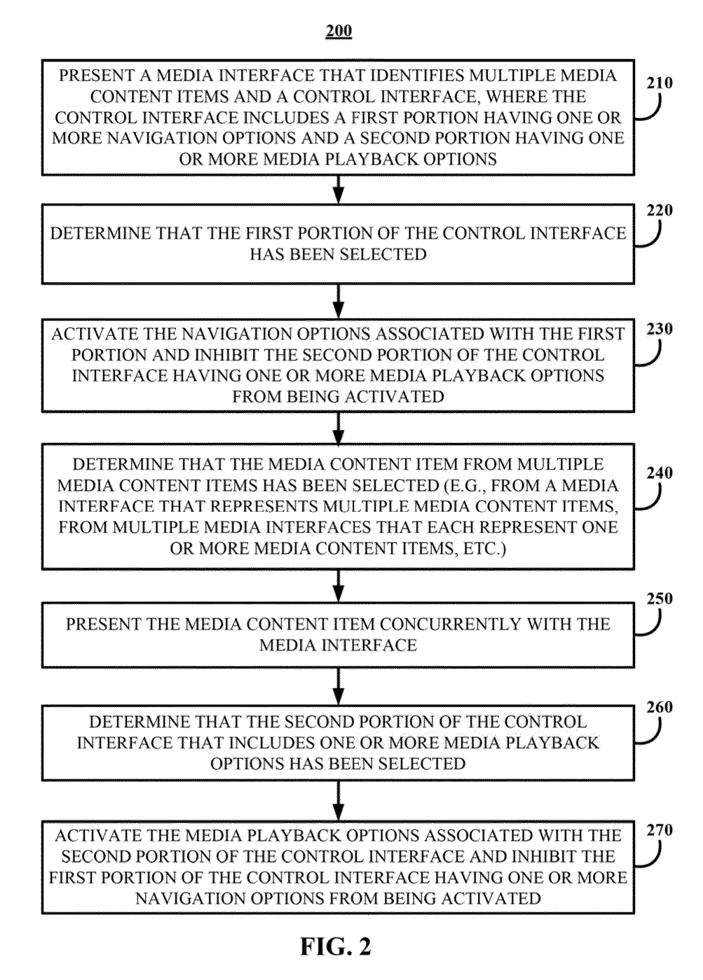

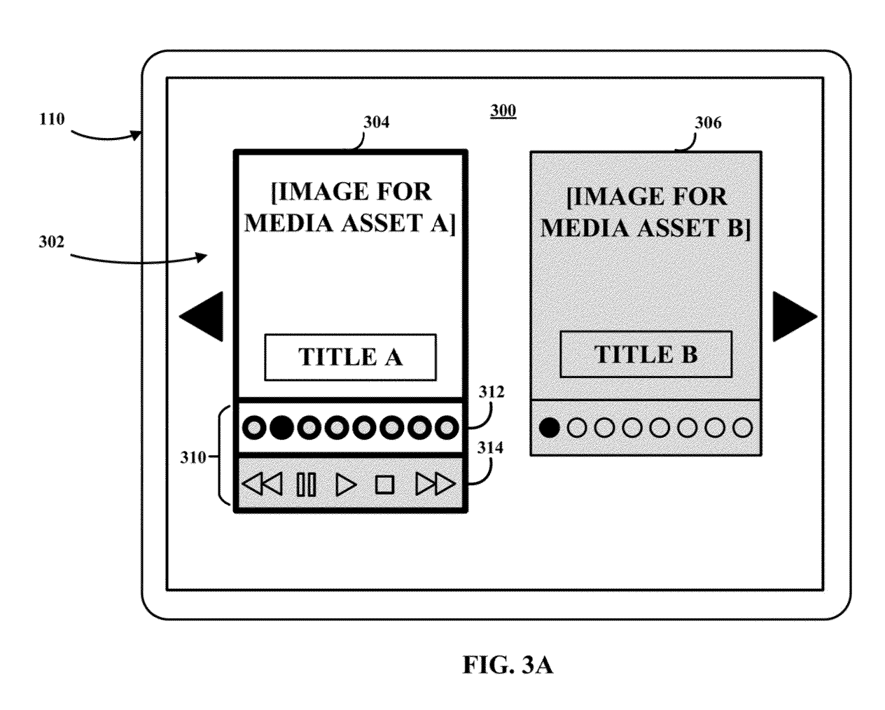

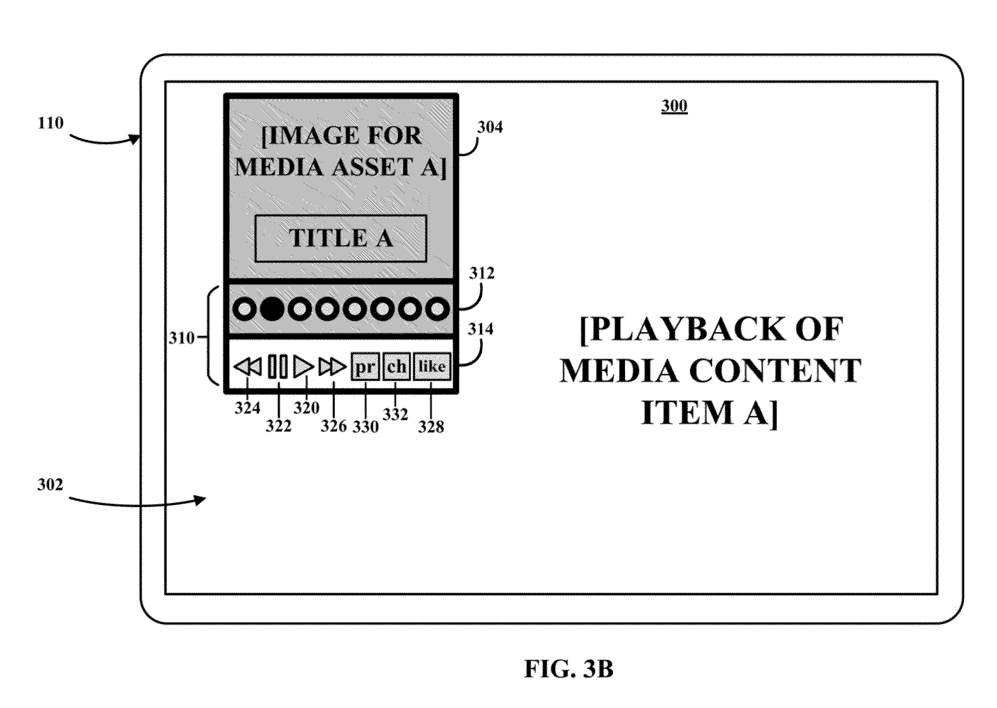

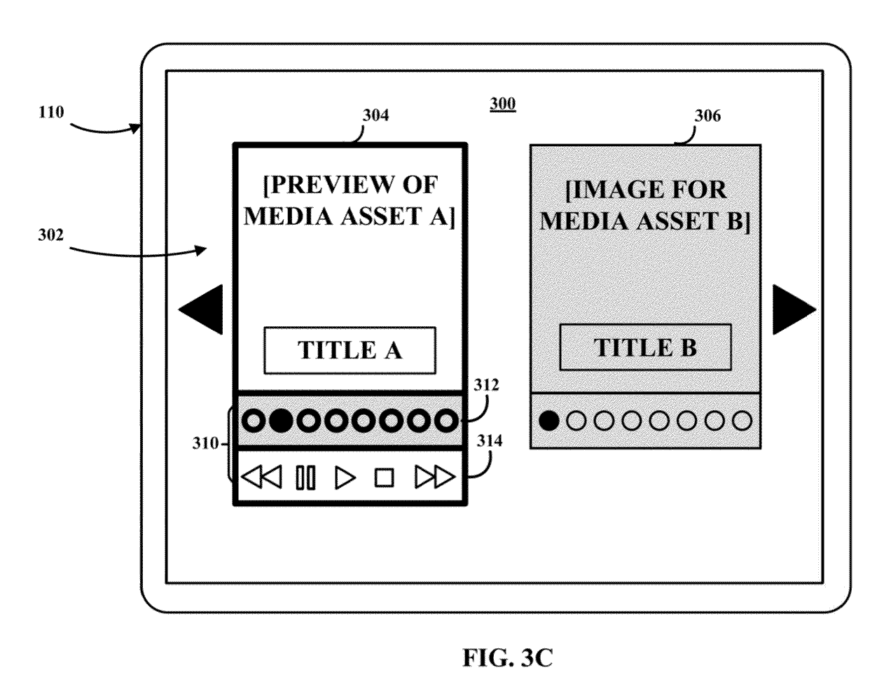

In some embodiments, system 100 can include one or more media devices 110, such as a media playback device for viewing media content listings and/or obtaining and presenting content items from various sources (e.g., broadcast content, on-demand content, locally stored content, Internet content, etc.). In some embodiments, remote control 120 and media device 110 can be local to each other or remote from each other. For example, remote control 120 and media device 110 can be located in the same room. In some embodiments, media device 110 can execute process 200 and/or present user interface 300, as described below in connection with FIGS. 2 and 3A-3C, respectively.

In some embodiments, media device 110 can include a display/input device 112, a processor 114, memory 116, and one or more transmitters, receivers, and/or transmitter/receivers 118, which can be interconnected.

In some embodiments, memory 116 can include a storage device, such as a hard drive, a digital video recorder, a solid state storage device, a removable storage device, or any other suitable device for storing guidance information and/or remote control instructions. In a more particular example, the storage device can store a computer program for controlling processor 114 in media device 110 (e.g., responsive to instructions received from remote control 120).

Processor 114 can use the computer program to present content on display/input device 112 and control a user interface, which can include user interface 300 as described below in connection with FIGS. 3A-3C, to allow a user to interact with the displayed content and to send and receive data through communication link 104 using transmitter/receiver 118. In some embodiments, transmitter/receiver 118 can transmit and/or receive radio signals, infrared signals, near-infrared signals, ultrasonic signals, etc. In cases where transmitter/receiver 126 of remote control 120 and transmitter/receiver 118 operate using different types of signals, a converter (not shown) can be used to convert instructions transmitted using one type of signal (e.g., a radio signal) to another type of signal (e.g., a near-infrared signal). It should be noted that data received through communications link 104 or any other communications links can be received from any suitable source. It should also be noted that transmitter/receiver 126 and transmitter/receiver 118 can operate using any suitable type of signals or combination thereof, including digital signals and/or analog signals.

Display/input device 112 can include input devices such as a computer keyboard, a cursor-controller, one or more buttons, a dial, a switchbank, a lever, a touchscreen, and/or any other suitable input device.

In some embodiments, remote control 120 and media device 110 can be any of a general purpose device such as a computer or a special purpose device such as a remote control, a smartphone, a tablet computer, a set-top box, a smart TV, a game console, a gamepad (e.g., a controller for a game console), a digital media receiver, a server, etc., or any suitable combination of such devices. Any of these general or special purpose devices can include any suitable components such as a hardware processor (which can be a microprocessor, digital signal processor, a controller, etc.), memory, communication interfaces, display controllers, input devices, etc. For example, media device 110 can be implemented as a set-top box, a digital media receiver, a smart TV, a television, a laptop computer, a personal computer, a server, a smartphone, a tablet computer, a game console, etc. In some embodiments, media device 110 can include a combination of devices, such as a television and a game console, or a television and a digital media receiver, where a first device (e.g., the game console or the digital media receiver) can execute the mechanisms described herein for presenting related content in a user interface navigated using directional controls, and a second device (e.g., the television) can be used to present a user interface for presenting related content in the user interface navigated using directional controls. Additionally or alternatively, instructions from a remote control can be received by a device that is not executing the mechanisms described herein (e.g., a television, a second screen device such as a smartphone, a game console) and these instructions can be relayed to a device that is executing the mechanisms described herein such as a digital media receiver, a streaming media device, or any other suitable device executing the mechanisms described herein.

Turning to FIG. 2, an illustrative example 200 of a process for providing a media interface with multiple control interfaces is shown in accordance with some embodiments of the disclosed subject matter. In some embodiments, process 200 can begin at 210 by presenting a media interface that identifies one or more media content items. For example, the media interface presented at 210 can be a user interface for selecting media content and the media identifier elements can identify the media content.

In some embodiments, a user interface that includes multiple media interfaces corresponding to various media content items can be presented. These media interfaces can be presented, for example, in a grid of media interfaces, as a column of media interfaces, as a row of media interfaces, as multiple rows of media interfaces with each row representing a group of related media interfaces, and/or using any other suitable technique or techniques. For example, as shown in FIG. 3A, media device 110 can include a display 302 (which can be part of display 112, described above in connection with FIG. 1) on which user interface 300 can be presented. User interface 300 can include various media interfaces 304 and 306 corresponding to different media assets. In some embodiments, user interface 300 can include any other suitable elements or other user interface components.

In some embodiments, a currently selectable element of user interface 300 can be highlighted. For example, as shown in FIG. 3A, media interface 304 is highlighted.

In some embodiments, a media interface can be highlighted using any suitable technique or combination of techniques. For example, a media interface can be highlighted by surrounding the element with a border of a particular color, brightness, pattern, etc. As another example, a color, shape, size, and/or any other suitable property or properties of the highlighted media interface can be altered with respect to other media identifier elements to indicate which media identifier element is highlighted. As yet another example, the highlighted media interface can be identified using text, graphics, or any other technique to differentiate the highlighted media identifier element. As still another example, the highlighted media interface can begin previewing the media asset to which it corresponds (e.g., can begin playing video of a video asset) to indicate that it is the highlighted media interface.

In some embodiments, as shown in FIG. 3A, media interface 306 can be de-emphasized, de-focused, and/or visually modified to appear inactive (e.g., by shading the media interface, by fading out the media interface, etc.). Additionally or alternatively, in response to highlighting a media interface, such as media interface 304, the other media interfaces presented in user interface 300 can be modified to appear inactive.

It should be noted that the one or more media interfaces can include any suitable information for presentation. For example, in some embodiments, the media interface can identify a media content item that corresponds to the media interface. In a more particular example, the media interface can include any suitable identifier, such as a thumbnail, an image, and/or any suitable text. In some embodiments, the media interface can identify the media content item from a plurality of media content items. For example, a thumbnail can identify a video content item from a plurality of video content items. In a more particular example, a thumbnail can identify a particular episode of a television program from a particular series of the television program.

In some embodiments, how a particular identifier is presented can be based on one or more items of metadata associated with the media content with which the media interface is associated. For example, the media identifier can include title information based on title metadata of the media content. As another example, the media identifier can include an image based on thumbnail metadata of the media content and/or a frame of image data from the metadata of the media content.

It should also be noted that the media content item that corresponds to a media interface can include any suitable type(s) of media content. For example, media content can include audio content and/or video content. As another example, media content can include print media content or image media content. As still another example, media content can include a collection of media content, such as a playlist of videos, a playlist of songs, a collection of images, etc. As a further example, media content can include subscription based media content, such as podcasts, online magazine subscriptions, etc. As another further example, media content can include interactive media content, such as applications and video games. Media content can include any suitable combinations of content and/or any other suitable content.

In some embodiments, the media interface can include multiple control interfaces. For example, as shown in FIG. 3A, media interface 304 includes a control interface 310, where a first portion 312 occupies the top of portion of the control interface and a second portion 314 occupies the bottom portion of the control interface. As also shown, the first portion 312 of the control interface can include navigation options (e.g., for navigating through multiple media content items when the media interface represents a collection of media content items). In instances where media interface 304 represents a playlist, navigation options can include a playlist indicator that indicates the number of media content items contained in the playlist. For example, as shown in FIG. 3A, the playlist indicator in first portion 312 can include multiple icons, such that the number of icons indicates the number of media content items contained in the playlist. In some such embodiments, any suitable icons, text, images, graphics, and/or any other suitable content can be included in the playlist indicator. As another example, in some embodiments, the playlist indicator can include a block of text stating the number of items contained in the playlist. The position of playlist indicator in media interface 304 is merely an example, and the playlist indicator in the navigation options can be presented at any suitable position.

In instances where media interface 304 represents a playlist of media content items, an item indicator can indicate which media content item from the playlist is currently being presented. Additionally or alternatively, multiple indicators can be presented—e.g., a first indicator that indicates which media content item from the playlist is currently being consumed and/or presented and a second indicator that indicates which media content item from the playlist has been navigated to.

Referring back to FIG. 2, process 200 can determine that the first portion of the control interface that includes navigation options has been selected at 220. For example, process 200 can determine that the first portion of the control interface has been selected in response to receiving any suitable directional inputs to navigate to the first portion of the control interface. In a more particular example, upon highlighting media interface 304, process 200 can receive a “down” directional command to navigate to the first portion of the control interface.

It should be noted that process 200 can receive any suitable directional input such as up, down, left, right, diagonals (e.g., up-right, down-left, etc.), analog directional inputs (e.g., received from an analog stick on a game controller), and/or any other suitable directional inputs. In some embodiments, the directional input can be a discrete and directionally constrained input, such as a directional input received from a direction pad on a remote control, as opposed to a non-constrained input received from a pointing device such as a mouse or track pad. Note that, in some embodiments, a directional input, such as a swipe or flick, from a touch interface can be a directional input as described herein.

In some embodiments, the directional input can be received by a device executing process 200 as a command or instruction from an input device (e.g., remote control 120). For example, if the device executing process 200 is a television, the directional input can be received from a television remote control or a universal remote control. As another example, if the device executing process 200 is a game console, the directional input can be received from a controller associated with the game console. Additionally or alternatively, the directional input can be received by another device, and relayed to the device executing process 200. For example, if the device executing process 200 is a digital media receiver, the directional input can be received by a television to which the digital media receiver is coupled, and can be relayed to the digital media receiver using any suitable technique (e.g., using a communications protocol such as consumer electronics control (CEC), using an infrared blaster, over a network to which both are coupled such as a local area network, etc.). As another example, if the device executing process 200 is a television, the directional input can be received by a game console coupled to the television (e.g., from a controller associated with the game console), and can be relayed to the digital media receiver using any suitable technique (e.g., using CEC, or any other suitable communication protocol over any suitable communications link).

In response to determining that the first portion of the control interface has been selected, process 200 can activate the navigation options associated with the first portion of the control interface. For example, as shown in FIG. 3A, first portion 312 of the control interface has been highlighted and the navigation options within first portion 312 allow the user to navigate through various media content items associated with media interface 304.

In some embodiments, the navigation options presented in the first portion of the control interface can be selected based on any suitable criterion (e.g., media type). For example, when the media interface represents a collection of media content items, navigation options that allow a user to scroll through the various media content items in the collection and indicators that indicate which media content item has been selected for playback or consumption and which media content item has been navigated to can be selected for the first portion of the control interface. In another example, when the media interface represents a single media content item, navigation options that allow a user to navigate to an adjacent media interface using a particular directional input (e.g., the right directional command) can be selected for the first portion of the control interface.

Additionally or alternatively, in response to determining that the first portion of the control interface has been selected, process 200 can also inhibit other portions of the control interface from being activated. For example, as shown in FIG. 3A, in response to receiving a directional input from a user input device to access the one or more navigation options in first portion 312, process 200 can activate the one or more navigation options for use in first portion 312 and inhibit the media playback options in second portion 314 from being activated.

In some embodiments, in response to initiating an application for browsing through media assets, process 200 can cause a default media interface to be highlighted and automatically cause the first portion of the control interface that includes options for navigating through media content items to be activated. Additionally or alternatively, process 200 can cause a media interface to be highlighted in response to receiving a directional input. For example, until a directional input is received, process 200 can inhibit any media interface from being highlighted, and upon receiving a directional input, can highlight a media interface based on the input. The media interface that is highlighted in response to receiving the directional input can be a media interface at a position based on the directional input (e.g., an upper media interface can be highlighted in response to receiving an “up” input), and/or can be a media interface at a default position (e.g., where there are multiple default positions and a directional input selects among the multiple default positions). In some embodiments, a media interface can be highlighted in response to navigation from a non-media interface that was highlighted (e.g., in response to directional inputs). Similarly, portions of control interface can be inhibited from being highlighted until a directional input is received (e.g., a “down” input when a media interface is currently highlighted or a “down” input when a portion of the control interface is currently highlighted).

Referring back to FIG. 2, process 200 can determine that a media content item has been selected from one or more media interfaces at 240. For example, when a media interface represents multiple media content items, process 200 can determine that a media content item from the multiple media content items has been selected. In another example, process 200 can determine that a media content item that is represented by one of multiple media interfaces has been selected. In a more particular example, as shown in FIG. 3A, process 200 can present media interface 304 which represents eight media content items (shown in the navigation controls in first portion 312) and determine that one of the media content items associated with media interface 304 has been selected.

In response to determining that a media content item has been selected, process 200 can present the media content item concurrently with the media interface at 250. For example, as shown in FIG. 3B, the media content item, such as a video, is concurrently presented along with media interface 304 on display 302 of media device 110. It should be noted that the media content can be presented along with the media interface in any suitable manner. For example, the media interface can be overlaid on top of the media content. In another example, the media interface can be presented on the left side of user interface 300 without obstructing the presentation of the media content.

At 260, process 200 can determine that another portion of the control interface has been selected. For example, process 200 can determine that the second portion of the control interface has been selected in response to receiving any suitable directional inputs to navigate to the second portion of the control interface. In a more particular example, as shown in FIG. 3B, upon highlighting and/or activating the first portion 312 of the control interface, process 200 can receive a “down” directional command to navigate to the second portion of the control interface.

In some embodiments, at 270, process 200 can activate the media playback options associated with the second portion of the control interface and inhibit the other portions of the control interface from being activated.

It should be noted that, in some embodiments, process 200 can, as a media content item has been selected for consumption, automatically de-activate or otherwise inhibit the use of the navigation controls in first portion 312 and activate other controls in control interface 310, such as the media playback options in second portion 314. In some embodiments, portions of media interface 304 can be de-activated or otherwise inhibited from being presented in response to activating the media playback options in second portion 314 of the control interface. For example, as shown in FIG. 3B, media identifier elements in media interface 304 can be shaded or darkened in response to activating second portion 314 of control interface 310.

As also shown in FIG. 3B, second portion 314 of the control interface 310 can include media playback options (e.g., for controlling the playback and/or presentation of the currently presented media content item). Media playback options can include any suitable media playback option, such as playing the media content item (a play option 320), pausing the media content item (a pause option 322), rewinding the media content item (a rewind option 324), fast forwarding the media content item (a forward option 326), stopping the media content item, skipping the media content item, liking the media content item or providing any other suitable indication of sentiment (a like option 328), requesting that related media content items be presented (a play related option 330), placing the media content item in a queue for consumption at a later time, subscribing to a content provider providing the media content item, accessing other content items provided by the content provider that is providing the media content item (a channel option 332), and/or any other suitable media playback option relating to the selected media content item.

In some embodiments, control interfaces and/or their respective options can be selected based on any suitable criterion. For example, media playback options in a control interface can be selected based on media type (e.g., particular options for video playback), media interface type (e.g., particular options for a playlist of media content items), content creator (e.g., particular options for accessing or subscribing to other content), user information (e.g., particular options for sharing and/or social media), etc. In a more particular example, playback options 320-326 can be provided in the control interface in response to determining that media interface 304 represents a media asset of a particular media type (e.g., a video, a slideshow, an audio clip, etc.). In another more particular example, like option 328 or other social media options can be provided in the control interface in response to determining that a social media account has been registered with media device 110. In yet another more particular example, channel option 332 can be provided in the control interface in response to determining that the content creator has a page containing other media content items for consumption and/or in response to determining that the content creator has other media content items available for consumption.

It should be noted that the control interface can have any suitable layout. For example, as shown in FIG. 3B, the control interface 310 is presented beneath the portion of media interface 304 that includes media interface elements (e.g., a thumbnail, a title, etc.) and has first portion 312 that includes navigation options and second portion 314 that includes media playback options, where first portion 312 is a top portion of control interface 310 and second portion 314 is a bottom portion of control interface 310. In another example, control interface 310 can be separated and presented beneath media interface 304, where the options provided in the multiple portions of the control interface can be vertically aligned.

It should also be noted that, in some embodiments, the directional inputs that can be received from a user input device can be based on the layout of the control interface. For example, as shown in FIGS. 3A and 3B, a selected portion of a control interface can be activated in response to receiving a directional input from a user input device to navigate in a vertical direction (e.g., an “up” directional command or a “down” directional command). As also shown, the options associated with the selected portion of the control interface can be navigated in response to receiving a direction input from the user input device in a horizontal direction. Alternatively, a portion of a control interface can be activated in response to receiving a directional input in a horizontal direction and the options associated with the selected portion of the control interface can be navigated in response to receiving a directional input in the vertical direction.

It should further be noted that, although control interface 310 in FIGS. 3A-3C includes first portion 312 and second portion 314, this is merely illustrative. Any suitable number of portions can be provided in control interface. For example, a first portion of the control interface can be used to navigate through a playlist of media content items represented by a media interface, a second portion of the control interface can be used to control playback or presentation of a particular media content item, a third portion of the control interface can be used to share, like, or perform social media functions associated with a particular media content item, etc. These various portions of the control interface can be activated and de-activated based on receiving particular directional inputs from a user input device and/or receiving particular user actions (e.g., selecting a media content item of a particular media type).

In some embodiments, multiple control interfaces can be presented concurrently with the consumption of a media content item and/or when navigating through various media interfaces that each represent one or more media content items. For example, FIG. 3B illustrates that multiple control interfaces can be presented concurrently with the presentation of media content—e.g., one control interface that controls the navigation through multiple media content items represented by a media interface and another control interface that controls the current media content item. In another example, FIG. 3C illustrates that multiple control interfaces can also be presented concurrently with the presentation of multiple media interfaces. In this example, a preview of the media content item currently navigated to in the media interface can be presented as part of the media interface and the navigation control options in second portion 314 of control interface 310 can be used to control the presentation of the preview. The preview can include any suitable content, such as a slideshow of images relating to the media content item, a video snippet of the media content item, etc.

It should be noted that the above steps of the flow diagram of FIG. 2 can be executed or performed in any order or sequence not limited to the order and sequence shown and described in the figure. Also, some of the above steps of the flow diagram of FIG. 2 can be executed or performed substantially simultaneously where appropriate or in parallel to reduce latency and processing times. Furthermore, it should be noted that FIG. 2 is provided as examples only. At least some of the steps shown in these figures may be performed in a different order than represented, performed concurrently, or altogether omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects. It should also be noted that, as used herein, the term mechanism can encompass hardware, software, firmware, or any suitable combination thereof.

Accordingly, methods, systems, and media for providing a media interface with multiple control interfaces are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for media guidance, the method comprising:
causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface;
determining that a portion of the control interface has been selected; and
activating the selected portion of the control interface, wherein:
the plurality of navigation options that navigate through the plurality of media content items are activated in response to determining that the first portion of the control interface has been selected; and
the plurality of media playback options that control playback of the media content item from the plurality of media content items are activated in response to determining that the second portion of the control interface has been selected.

2. The method of claim 1, further comprising causing the media content item to be presented concurrently with the media interface in response to determining that the media content item from the plurality of media content items has been selected using the first portion of the control interface.

3. The method of claim 1, further comprising inhibiting the second portion of the control interface from being activated in response to determining that the first portion of the control interface has been selected.

4. The method of claim 1, further comprising inhibiting the first portion of the control interface from being activated in response to determining that the second portion of the control interface has been selected.

5. The method of claim 1, wherein the media interface includes a plurality of media identifiers and wherein each of the plurality of media identifiers includes an image that represents the media content item of the plurality of media content items.

6. The method of claim 1, wherein the first portion is a top portion of the control interface and wherein the second portion is a bottom portion of the control interface.

7. The method of claim 1, wherein the selected portion of the control interface is activated in response to receiving a user input to navigate in a vertical direction and wherein the method further comprises navigating through options associated with the selected portion of the control interface in response to receiving a user input to navigate in a horizontal direction.

8. The method of claim 1, wherein the selected portion of the control interface is activated in response to receiving a user input to navigate in a horizontal direction and wherein the method further comprises navigating through options associated with the selected portion of the control interface in response to receiving a user input to navigate in a vertical direction.

9. A system for media guidance, the system comprising:
a hardware processor that is configured to:
cause a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface;
determine that a portion of the control interface has been selected; and
activate the selected portion of the control interface, wherein:
the plurality of navigation options that navigate through the plurality of media content items are activated in response to determining that the first portion of the control interface has been selected; and
the plurality of media playback options that control playback of the media content item from the plurality of media content items are activated in response to determining that the second portion of the control interface has been selected.

10. The system of claim 9, wherein the hardware processor is further configured to cause the media content item to be presented concurrently with the media interface in response to determining that the media content item from the plurality of media content items has been selected using the first portion of the control interface.

11. The system of claim 9, wherein the hardware processor is further configured to inhibit the second portion of the control interface from being activated in response to determining that the first portion of the control interface has been selected.

12. The system of claim 9, wherein the hardware processor is further configured to inhibit the first portion of the control interface from being activated in response to determining that the second portion of the control interface has been selected.

13. The system of claim 9, wherein the media interface includes a plurality of media identifiers and wherein each of the plurality of media identifiers includes an image that represents the media content item of the plurality of media content items.

14. The system of claim 9, wherein the first portion is a top portion of the control interface and wherein the second portion is a bottom portion of the control interface.

15. The system of claim 9, wherein the selected portion of the control interface is activated in response to receiving a user input to navigate in a vertical direction and wherein the hardware processor is further configured to navigate through options associated with the selected portion of the control interface in response to receiving a user input to navigate in a horizontal direction.

16. The system of claim 9, wherein the selected portion of the control interface is activated in response to receiving a user input to navigate in a horizontal direction and wherein the hardware processor is further configured to navigate through options associated with the selected portion of the control interface in response to receiving a user input to navigate in a vertical direction.

17. A non-transitory computer-readable medium containing computer-executable instructions that, when executed by a processor, cause the processor to perform a method for media guidance, the method comprising:
causing a media interface to be presented, wherein the media interface identifies a plurality of media content items and includes a control interface, wherein the control interface includes a first portion having a plurality of navigation options that navigate through the plurality of media content items and a second portion having a plurality of media playback options that control playback of a media content item from the plurality of media content items that has been navigated to using the first portion of the control interface;
determining that a portion of the control interface has been selected; and
activating the selected portion of the control interface, wherein:
the plurality of navigation options that navigate through the plurality of media content items are activated in response to determining that the first portion of the control interface has been selected; and
the plurality of media playback options that control playback of the media content item from the plurality of media content items are activated in response to determining that the second portion of the control interface has been selected.

18. The non-transitory computer-readable medium of claim 17, wherein the method further comprises causing the media content item to be presented concurrently with the media interface in response to determining that the media content item from the plurality of media content items has been selected using the first portion of the control interface.

19. The non-transitory computer-readable medium of claim 17, wherein the method further comprises inhibiting the second portion of the control interface from being activated in response to determining that the first portion of the control interface has been selected.

20. The non-transitory computer-readable medium of claim 17, wherein the method further comprises inhibiting the first portion of the control interface from being activated in response to determining that the second portion of the control interface has been selected.

21. The non-transitory computer-readable medium of claim 17, wherein the media interface includes a plurality of media identifiers and wherein each of the plurality of media identifiers includes an image that represents the media content item of the plurality of media content items.

22. The non-transitory computer-readable medium of claim 17, wherein the first portion is a top portion of the control interface and wherein the second portion is a bottom portion of the control interface.

23. The non-transitory computer-readable medium of claim 17, wherein the selected portion of the control interface is activated in response to receiving a user input to navigate in a vertical direction and wherein the method further comprises navigating through options associated with the selected portion of the control interface in response to receiving a user input to navigate in a horizontal direction.

24. The non-transitory computer-readable medium of claim 17, wherein the selected portion of the control interface is activated in response to receiving a user input to navigate in a horizontal direction and wherein the method further comprises navigating through options associated with the selected portion of the control interface in response to receiving a user input to navigate in a vertical direction.
